(19) United States
(12) Patent Application Publication
(10) Pub. No.: US 2009/0207608 A1
(43) Pub. Date: Aug. 20, 2009

(54) LIGHTING DEVICE

(76) Inventor: Morton Graham, Lancashire (GB)

Correspondence Address: GAUTHIER & CONNORS, LLP, 225 FRANKLIN STREET, SUITE 2300, BOSTON, MA, 02110, US

(21) Appl. No.: 12/413,921

(22) Filed: Mar. 30, 2009

Related U.S. Application Data
(63) Continuation of application No. PCT/GB2007/003834, filed on Oct. 10, 2007.

(30) Foreign Application Priority Data
Oct. 11, 2006 (GB) 0620096.8

(51) Int. Cl. F21V 11/00; F21V 21/00

(52) U.S. Cl. 362/235; 362/249.02

(57) ABSTRACT

A lighting device (10) for use within a light box or light panel and comprising a housing with generally parallel upper and lower walls (11, 12) and diverging side walls (13, 14) with one or more LEDs (18) disposed within the housing on a back wall (15) thus to project light outwardly from the housing. Several such devices may be disposed within a light box or light panel to project light across the latter which light is then diffused before exiting from a front display panel or the like. The diffused light conceals the lighting devices within the light box or light panel. Such devices are intended to replace conventional fluorescent or neon lighting tubes or tungsten lights to produce substantially uniform light distribution by diffusion within the light box or light panel and incorporating low voltage and low power consuming light sources.

### PRIORITY INFORMATION

This application is a continuation of International Application No. PCT/GB2007/003834 filed on Oct. 10, 2007 which claims priority to Great Britain Patent Application No. 0620096.8 filed on Oct. 11, 2006, all of which are incorporated by reference in their entirety herein.

### BACKGROUND OF THE INVENTION

1. Field of the Invention

This invention concerns a lighting device for use, for example, in a so-called light box or display panel, or an illumination panel for room lighting.

2. Brief Description of the Prior Art

There is increasing interest, in lighting devices, in the use of light emitting diodes (LEDs) which are low voltage devices with low power consumption yet producing, in many cases, sufficient brilliance to replace conventional fluorescent or neon tube lighting or tungsten lighting.

### SUMMARY OF THE INVENTION

It is an object of the present invention to enhance the light emitting properties of one or more LEDs to illuminate the interior, for example, of a light box, display panel or ceiling lighting tile or panel.

According to the present invention there is provided a lighting device comprising an open-fronted housing defined by upper and lower spaced walls and diverging side walls, at least one LED disposed in the housing remote from its open front, and electrical supply means for the or each LED.

The upper and lower spaced walls may be substantially parallel.

The diverging side walls may be generally straight and substantially define a right angle.

The diverging side walls may extend from a back wall which is substantially parallel to the open front of the housing.

Means may be provided for attachment of the device to a surface.

The attachment means may be a rearward extension of the lower wall with an aperture for receiving a pin, stud or screw.

At least some of the interior wall surfaces of the housing may be light-coloured to reflect light from the or each LED.

At least one exterior wall surface of the housing may be light-coloured to reflect diffused light issuing from the device.

The diverging side walls may be curved.

The housing may be predominantly of metal to dissipate heat from the or each LED.

The lighting device, or several such devices, may be enclosed within a light box or light panel having a translucent front wall, such that light emitting from the or each such device is diffused within the light box or light panel before exiting from the translucent front wall whereby the or each lighting device is concealed by the diffused light within the light box or light panel.

The light box or light panel may be of rectangular or polygonal shape with two or more such lighting devices located in two or more corners thereof to project light across the light box or light panel for diffusion therewithin.

### BRIEF DESCRIPTION OF THE DRAWINGS

Embodiments of the invention will now be described, by way of example only, with reference to the accompanying schematic drawings, in which:

FIG. 1 is a plan view of a lighting device made in accordance with the invention;

FIG. 2 is a cross-section taken on line 2-2 of FIG. 1;

FIG. 3 is a plan view of a light box or light panel incorporating several such devices;

FIG. 4 is a cross-sectional diagonal view of a light box or light panel incorporating such devices;

FIG. 5 is a plan view of a triangular light box or light panel incorporating three such devices; and

FIG. 6 is a plan view of an elliptical light box or light panel incorporating two such devices.

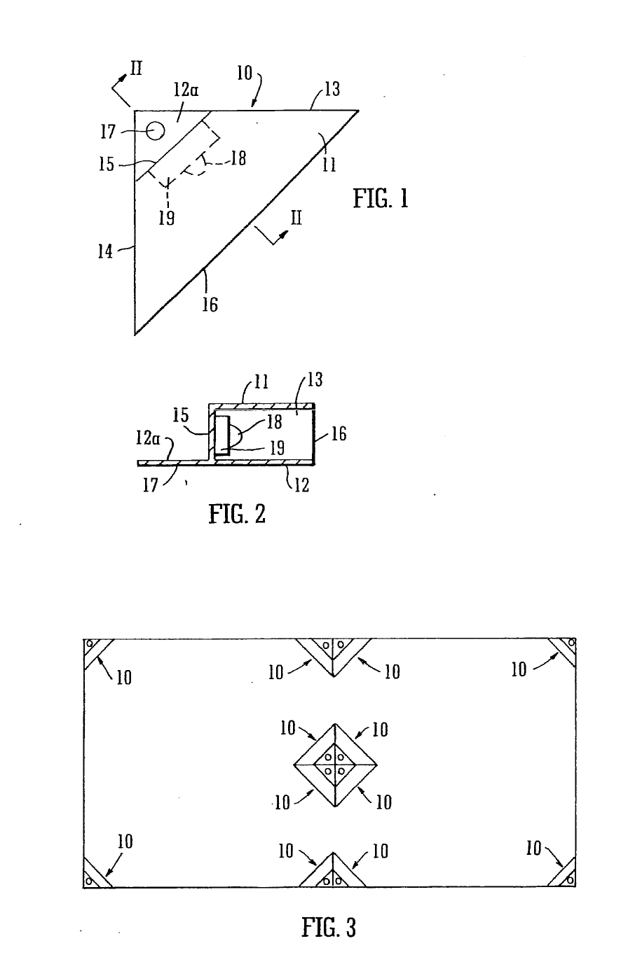

### DETAILED DESCRIPTION OF THE INVENTION

Referring now to the drawings, a lighting device comprises an open fronted housing 10 defined by upper and lower generally parallel walls 11, 12 and diverging side walls 13, 14 which together define a right angle and a back wall 15 generally parallel to the open front 16 of the device. A rearward continuation of the lower wall 12 forms an attachment tab 12a with an aperture 17 to receive a pin, stud or screw.

Fixedly attached to the inner surface of the back wall 15 within the housing 10 is an LED 18 on an electrical supply circuit board 19. A supply lead (not shown) will be connected to the board 19 to power the LED 18. Instead of a single LED 18 an array of such LEDs may be provided on the board 19.

The housing 10 may be of plastics with the board 19 consisting of an aluminium plate attached to a further metal plate which acts to dissipate the heat generated by the LED 18 in use. All interior surfaces of the housing 10 are preferably coated with a white or light coloured paint thus to reflect light from the LED 18 outwardly from the open front 16 of the housing.

The exterior surface of the upper wall 13 is also similarly light-coloured.

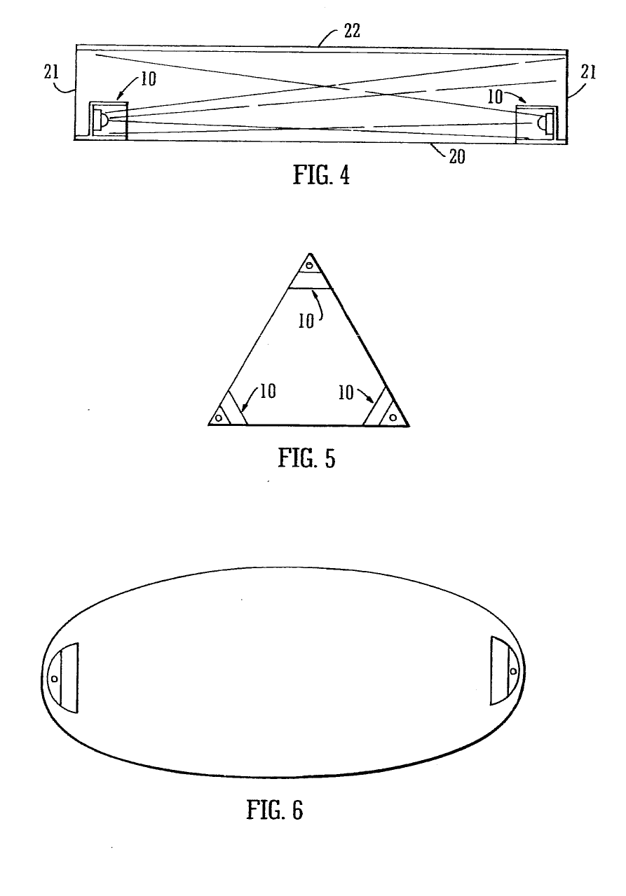

Referring now to FIG. 3, in one embodiment, four such lighting devices are enclosed within a rectangular light box or light panel so that each device projects light outwardly across the interior of the panel. The panel, as illustrated in FIG. 4, will have an opaque base 20 and shallow side walls 21 with a translucent top 22 which may carry a graphic, such as an advertising display, to be illuminated from within the panel.

The depth of each lighting device 10 may be in the region of 10 mm while the depth of the light panel defined by the walls 21 may be in the region of 25 mm, such that the panel has a depth less than three times that of each device 10. In some cases, however, the panel can be of considerably greater depth than the devices 10.

In use, light is projected from each lighting device into the light panel where it is diffused before exiting through the translucent front wall 22. The diffused light conceals the upper surface of each lighting device 10 so that a substantially uniform light distribution across the front wall 22 is achieved, while the lighting devices 10 are effectively concealed by the diffused light, and by the reflective nature of the light-coloured coating on the tops of the devices.

As shown in FIG. 3, in addition to such devices disposed in each of the four corners of a rectangular panel additional such devices may be provided centrally and/or part-way along the sides, particularly in large panels, in order to ensure a uniform distribution of the light exiting the front wall 22.

Referring now to FIG. 5, an example is shown of a triangular lighting panel with lighting devices in the three corners.

FIG. 6 shows an example of an elliptical panel with two such devices at opposed ends. In this case, the diverging walls of each device are of a curved configuration. Any shape of panel may be provided with such devices located and deployed appropriately within the interior of the enclosed panel.

These panels can be used either for display purposes such as for commercial advertising or for ceiling lighting tiles for room illumination.

It is not intended to limit the invention to the above example only. For example, the upper and lower walls 11 and 12 may themselves be of diverging form to ensure adequate spread of the light issuing from the open front 16 of the device.

Furthermore, a number of such devices may be used for concealed lighting such as under cupboards and in display cabinets where they would be concealed by an opaque panel to avoid direct visibility of the LEDs themselves, the illumination being provided by the diffused light issuing from the open fronts 16 of the devices.

What is now claimed:

1. A lighting device comprising an open fronted housing defined by upper and lower spaced walls and diverging side walls, at least one LED disposed in the housing remote from its open front, and electrical supply means for the or each LED.

2. The lighting device according to claim 1 wherein the upper and lower spaced walls are substantially parallel.

3. The lighting device according to claim 1 wherein the diverging side walls are generally straight and substantially define a right angle.

4. The lighting device according to claim 1 wherein the diverging side walls extend from a back wall which is substantially parallel to the open front of the housing.

5. The lighting device according to claim 1 including means for attachment of the device to a surface.

6. The lighting device according to claim 5 wherein the attachment means is a rearward extension of the lower wall with an aperture for receiving a pin, stud or screw.

7. The lighting device according to claim 1 wherein at least some of the interior wall surfaces of the housing are light-coloured to reflect light from the or each LED.

8. The lighting device according to claim 1 wherein at least one exterior wall surface of the housing is light-coloured to reflect diffused light issuing from the device.

9. The lighting device according to claim 1 wherein the diverging side walls are curved.

10. The lighting device according to claim 1 wherein the housing is of plastics with an insert of metal to dissipate heat from the or each LED.

11. The lighting device or several such devices according to claim 1 enclosed within a light box or light panel having a translucent front wall such that light emitting from the or each such device is diffused within the light box or light panel before exiting from the translucent front wall whereby the or each lighting device is substantially concealed by the diffused light within the light box or light panel.

12. The lighting device according to claim 11, wherein the light box or light panel has a depth less than three times that of the lighting device or devices.

13. The lighting device enclosed within a light box or light panel according to claim 11 wherein the latter is of rectangular or polygonal shape with two or more such lighting devices located in two or more corners thereof to project light across the light box or light panel for diffusion therewithin.
